(19) United States
(12) Patent Application Publication
(10) Pub. No.: US 2026/0225473 A1
(43) Pub. Date: Aug. 6, 2026

(54) BATTERY HOUSING AND BATTERY SYSTEM

(71) Applicant: MAHLE International GmbH, Stuttgart (DE)

(72) Inventors: Joerg Heinrich, Stuttgart (DE); Christopher Laemmle, Stuttgart (DE); Dieter Reisinger, Muehlacker (DE); Holger Schroth, Maulbronn (DE)

(21) Appl. No.: 19/149,524

(22) PCT Filed: Jan. 19, 2024
(86) PCT No.: PCT/EP2024/051264

§ 371 Date: Jul. 18, 2025

(30) Foreign Application Priority Data
Jan. 20, 2023 (DE) 10 2023 200 445.3

(51) Int. Cl. B60L 50/64; B60K 1/04; H01M 10/46; H01M 50/204; H01M 50/249; H02J 50/10

(52) U.S. Cl. CPC B60L 50/64; B60K 1/04; H01M 10/46; H01M 50/204; H01M 50/249; H02J 50/10; B60K 2001/0438; H01M 2220/20

(57) ABSTRACT

A battery housing for an electric or hybrid vehicle includes upper and lower housing parts that define a housing interior for battery cell modules. The lower housing part features a trough-like recess, tapering toward the upper part, configured to accommodate an induction charging device for wireless charging of the traction battery.

### CROSS-REFERENCE TO RELATED APPLICATIONS

This application claims priority to International Patent Application No. PCT/EP 2024/051264, filed on Jan. 19, 2024, and German Patent Application No. 102023200445.3, filed on Jan. 20, 2023, the contents of both of which are hereby incorporated by reference in their entirety.

### TECHNICAL FIELD

The disclosure relates to a battery housing for accommodating a traction battery comprising several battery cell modules in an electric or hybrid vehicle. The disclosure also relates to a battery system with such a battery housing and a motor vehicle with such a battery system.

### BACKGROUND

Motor vehicles usually have an electrical energy storage device, for example a rechargeable battery, for the electrical supply of electrical consumers. In particular in motor vehicles that are at least partially electrically powered, the electrical energy storage device, which for the sake of simplicity will be referred to as a “battery” in the following, is used to power the motor vehicle. Such a battery is known as a “traction battery”. It is also known to charge the motor vehicle, i.e., in particular the battery installed in the motor vehicle, inductively. Corresponding charging systems have a coil in the motor vehicle and outside the motor vehicle. Outside the motor vehicle, there is typically a stationary charging device with a primary coil, which interacts inductively with a mobile inductive charging device provided in the motor vehicle and having a secondary coil in order to transfer energy to the battery and thereby charge the battery electrically.

### SUMMARY

The assembly in the vehicle is also referred to as a vehicle assembly. The assembly outside the vehicle is usually located underneath the vehicle during operation and is also referred to as the ground assembly.

To ensure good inductive coupling between the vehicle assembly and the ground assembly, the inductive charging device is typically located as low as possible on the motor vehicle, usually in the region of the vehicle underbody. However, for reasons of space, it is also common practice to place the battery cells in a battery housing and to locate this in the region of the underbody as well.

The present disclosure provides an improved design for a battery housing which is designed to accommodate a battery, in particular a traction battery, and also to accommodate an inductive charging device, and which is characterized in particular by reduced interference from the battery housing with the magnetic field to be received by the charging device.

This object is achieved by the scope of the independent claims. Preferred embodiments are the scope of the dependent claims.

The basic idea behind the disclosure is therefore to provide a recess on the battery housing for accommodating an inductive charging device with a bevelled rim. It has been shown that this influences the field lines of the alternating magnetic field generated between the primary coil and the secondary coil in such a way that improved magnetic coupling can be achieved com-pared to battery housings that do not have such a bevel. This also ensures that the battery housing mechanically shields the battery cells located in the housing interior and also provides electro-magnetic shielding. At the same time, unwanted electromagnetic shielding of the inductive charging device by the battery housing with respect to the ground assembly is prevented or at least reduced and, as a result, unwanted interference with the magnetic field lines generated by the primary coil and received by the secondary coil on the motor vehicle is kept to a minimum.

Specifically, the battery housing according to the disclosure comprises an upper housing part and a lower housing part opposite the upper housing part, which together at least partially delimit a housing interior. In a longitudinal section of the battery housing, the lower part of the housing forms a trough-like recess for accommodating a mobile inductive charging device. As explained above, the mobile charging device can interact with a stationary charging device arranged on the roadway or similar surface accessible to motor vehicles for wireless inductive energy transfer from the stationary charging device to the mobile charging device.

According to the disclosure, the recess tapers toward the upper part of the housing in the longitudinal section. In this way, the magnetic field lines of the magnetic field can be improved during the inductive transmission of energy to an inductive charging device with a (secondary) coil accommodated in the recess, which increases the efficiency of the energy transmission and thus reduces thermal losses. This also results in simplifications in the cooling of the inductive charging device.

In a preferred embodiment of the battery housing, the trough-like recess in the longitudinal section has a pot-like geometry with a pot base, at both opposite ends of which a pot collar protruding from the pot base is connected. In the longitudinal section, the two pot collars are each arranged at an acute angle to the pot base. In this way, a particularly advantageous deflection of the magnetic field lines between the primary coil and the secondary coil can be achieved if an inductive charging device with the (secondary) coil is arranged in the recess.

The preferred acute angle is between 15° and 75°. This is accompanied by a particularly advantageous field line pattern.

It is particularly preferred that the material of the lower housing part, at least in the region of the recess, comprises an electrically conductive material or comprises an electrically conductive material. A metal such as aluminum is therefore a suitable material for this purpose. This ensures effective electromagnetic shielding of the components located in the housing interior, in particular the battery cells, but also any power electronics and/or control electronics located in the housing interior.

According to an advantageous further development of the disclosure, a magnetic conductor is arranged in the longitudinal section on an outer side of the lower housing part facing away from the housing interior, at least on a rim region of the lower housing part delimiting the recess. Such a magnetic conductor improves the electromagnetic shielding properties of the battery housing to shield the housing interior and also causes additional deflection of the magnetic field lines, so that the magnetic conductor can be used to further optimize the field line pattern.

Such a magnetic conductor is characterized in particular by a material with a relative permeability μᵣ>1.0. A magnetically conductive material with a relative permeability μᵣ>100, as is common in soft magnetic materials (e.g., ferrite), is particularly preferred. The magnetic conductor can be particularly useful if it is made of or includes a film of such a magnetically conductive material. Such a film is inexpensive to purchase and can also be easily fastened to the battery housing.

According to a further advantageous refinement, the film has a main portion arranged on the rim region and an extension portion arranged in the trough-like recess in the longitudinal section.

Preferably, the extension portion can be formed in the longitudinal section as a protrusion extending into the recess. In this variant, the extension portion or protrusion extends the main portion in a straight line or, alternatively, extends from the main portion at an acute angle into the recess. Both variants have a particularly beneficial effect on the field lines of the magnetic field.

According to further advantageous development, the protrusion rests on the pot collar. This variant is particularly simple and can be mechanically fastened to the battery housing. Alternatively, the protrusion in this further processing can also extend at an angle into the recess and be positioned at a distance from the pot collar. In this case, the rim region of the lower housing part that delimits the recess is also particularly well magnetically shielded.

The material of the magnetic conductor or film may preferably be a ferrite.

In another preferred embodiment, the trough depth of the trough-like recess, measured along a vertical direction of the battery housing, is between 10 mm and 40 mm. In this way, the installation space available in the region of the recess between the lower housing part and the upper housing part can be used effectively to accommodate components with a low installation height, even though the installation height is reduced.

According to another advantageous further development, at least one electrical feed-through, preferably two or more, and particularly preferably at least three electrical feed-throughs, are formed in the lower housing part in the region of the recess. By means of such an electrical feed-through, power and/or control electronics arranged in the housing interior in an interior region between the upper housing part and the recess can be electrically led out of the housing interior to the outside.

In particular, the at least one electrical feed-through may be designed as an electrical plug contact or comprise an electrical plug contact into which the power/control electronics can be mechanically and electrically plugged. This allows the power/control electronics to be not only routed electrically out of the housing interior, but also fixed mechanically to the battery housing in a stable manner, in conjunction with additional mechanical connecting elements.

In an alternative preferred embodiment, the electrical feed-throughs can also be connected indirectly to the battery via flexible cable ends of the inductive charging device. The flexible cable ends of the inductive power electronics run in a further cavity between the housing of the inductive charging device and the lower part of the battery housing and are connected in this cavity to the contacts passing through the lower part of the battery housing in a suitable manner, in particular by means of a plug connection or screw connection or crimp connection.

In another preferred embodiment, a mechanical reinforcement element made of plastic is arranged in the longitudinal section on the outer side of the lower housing part facing away from the housing interior in the region of the recess, preferably in the region of the pot collar.

This allows the induction charging device to be fastened to the housing in a particularly stable manner.

According to an advantageous further development, the at least one reinforcement element comprises a screw receptacle for accommodating a plastic screw. This enables mechanically stable yet detachable fastening of the inductive charging device by means of a screw connection.

In alternative embodiments, clamp, clip, or bayonet connections, or any combination of all the connection methods mentioned above, are also conceivable for fastening the inductive charging device. Furthermore, it is also conceivable that individual connecting elements, for reasons of strength, are not made of an electromagnetically neutral material such as plastic, but comprise entirely or partially of electrically conductive material, which thus also influences the field lines of energy transmission. In such cases, care must be taken to ensure that the installation location of the metallic materials is magnetically shielded, if necessary by suitably incorporating magnetically conductive materials. For this purpose, the magnetic conductor or magnetically conductive film mentioned above can also be used in the rim region of the recess.

The disclosure also relates to a battery system for a motor vehicle with electric drive. The battery system comprises a battery housing as described above, so that the advantages of the battery housing described above are transferred to the battery system according to the disclosure. The battery system according to the disclosure further comprises a rechargeable electric traction battery arranged in the housing interior and comprising several battery cell modules. Furthermore, the battery system according to the disclosure comprises an inductive charging device arranged in the recess for electrically charging the traction battery. The inductive charging device comprises at least one coil for receiving an alternating electromagnetic field.

In a preferred embodiment of the battery system according to the disclosure, the charging device is arranged completely within the recess. If the battery system is installed in a motor vehicle, where it is typically located in the region of the underbody of the motor vehicle, this prevents the charging device from protruding downward and thus being exposed to an increased risk of damage or even destruction, especially when the motor vehicle is in operation. It is particularly preferred that the recess is largely symmetrical with respect to a vehicle center axis defined in relation to the direction of travel and also largely centered between the axles of the vehicle.

Furthermore, it is particularly advantageous if power/control electronics connected electrically to the charging device are arranged in the interior region of the housing interior between the recess and the upper housing part. In this way, the installation space still available in the region of the recess between the lower housing part and the upper housing part can be used effectively for arranging components with a sufficiently low installation height, with a reduced installation height.

In a preferred embodiment of the battery system according to the disclosure, the magnetic conductor extends laterally at most to the inductive charging device. This prevents unwanted electromagnetic shielding of the coil of the charging device by the magnetic conductor.

In another preferred embodiment of the battery system according to the disclosure, the charging device has a transformer core made of ferrite. In this embodiment, the magnetic conductor extends toward the upper housing part at most up to the transformer core. This measure also prevents unwanted electromagnetic shielding of the coil(s) of the charging device by the magnetic conductor.

The disclosure also relates to a motor vehicle, in particular a hybrid vehicle or an electric vehicle with electric drive. The motor vehicle comprises a vehicle interior and an electric drive system for powering the motor vehicle. Furthermore, the motor vehicle comprises a battery system according to the disclosure, described above, for supplying electrical energy to the electric drive system. Thus, the advantages of the battery housing according to the disclosure described above are also transferred to the motor vehicle according to the disclosure.

In a preferred embodiment of the motor vehicle according to the disclosure, the battery system is arranged in a lower region of the motor vehicle between the vehicle interior and an underbody of the motor vehicle. The upper part of the housing faces the vehicle interior and the lower part of the housing with the inductive charging device faces the underbody. This enables efficient inductive magnetic coupling of the charging device with the stationary inductive charging device mentioned above, which is typically arranged on a road surface that can be driven on by motor vehicles, and thus particularly efficient transmission of energy to the inductive charging device and thus to the traction battery connected electrically to this device.

Other important features and advantages of the disclosure can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the present disclosure.

Preferred exemplary embodiments of the disclosure are shown in the drawings by way of example and will be explained in more detail in the following description, wherein identical reference signs refer to identical or similar or functionally identical elements.

### BRIEF DESCRIPTION OF THE DRAWINGS

The following is shown-schematically in each case-in the images below:

FIG. 1 an example of a motor vehicle according to the disclosure,

FIG. 2a an example of a battery system according to the disclosure with a battery housing and an inductive charging device,

FIG. 2b detailed view of FIG. 2a showing the battery system or battery housing of FIG. 2a in the region of the recess in the lower part of the housing in which the inductive charging device is accommodated,

FIG. 2c detailed view of FIGS. 2a and 2b in the rim region of the recess,

FIG. 3 a further development of the example shown in FIG. 2a, in which a magnetic conductor is arranged in the region of the recess rim for electromagnetic shielding of the magnetic field coupled into the inductive charging device, and

FIG. 4a-4c detailed views of the example shown in FIG. 3 in the region of the recess rim with the magnetic conductor arranged on the recess rim.

### DETAILED DESCRIPTION

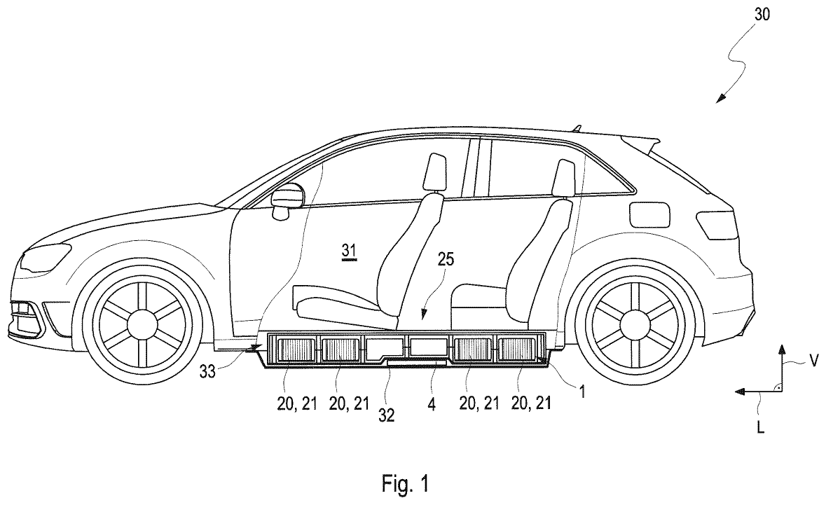

FIG. 1 shows a motor vehicle 30 according to the disclosure. The motor vehicle 30 may be a hybrid vehicle or an electric vehicle. The motor vehicle 30 comprises a vehicle interior 31 and an electric drive system (not shown) for powering the motor vehicle 30. Furthermore, the motor vehicle 30 comprises a battery system 25 according to the disclosure for supplying the electric drive system with electrical energy.

As shown in FIG. 1, the battery system 25 is arranged in a lower region 33 of the motor vehicle 30 between the vehicle interior 31 and an underbody 32 of the motor vehicle 30. The battery system 25 according to the disclosure comprises a battery housing 1 according to the disclosure, which delimits a housing interior 4. The battery system 25 according to the disclosure further comprises a traction battery 20 arranged in the housing interior 4 of the battery system 25, which has several electrically rechargeable battery cell modules 21.

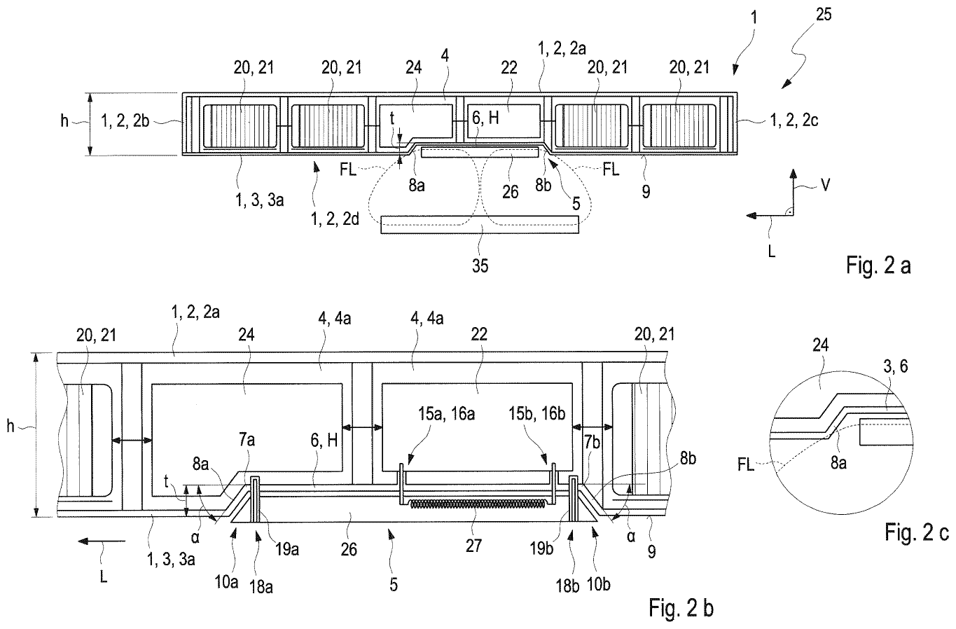

FIGS. 2a and 2b show examples of the battery system 25 according to the disclosure in a longitudinal section along a longitudinal direction L of the motor vehicle 30 of FIG. 1. FIG. 2b is a detailed representation of FIG. 2a. The battery housing 1 comprises an upper housing part 2 and a lower housing part 3 opposite the upper housing part 2, which together delimit the housing interior 4. The upper housing part 2 faces the vehicle interior 31 and the lower housing part 3 faces the underbody 32 of the motor vehicle 30 (see FIG. 1).

The battery housing 1 can be designed in two parts, as indicated in the longitudinal section in FIG. 2a, comprising the upper housing part 2 and the lower housing part 3. In this case, the upper housing part 2 can be designed as a pot with a housing pot base 2a and two housing collars 2b, 2c protruding from the end of the housing pot base 2a, as shown, and can also have a housing opening 2d. In this scenario, the lower housing part 3 can be designed as a housing cover 3a to close the housing opening 2d. The housing material of the lower housing part 3 or the housing cover 3a is preferably an electrically conductive material, in particular a metal such as aluminum. The housing material of the upper housing part 2 can also be an electrically conductive material, in particular a metal such as aluminum. It is particularly advantageous if the lower housing part 3 and the upper housing part 2 are made of the same material.

In the longitudinal section of the battery housing 1 shown, the lower housing part 3 delimits a trough-like recess 5 which is designed to accommodate a mobile induction charging device 26. FIG. 2b shows the battery housing 1 in the region of the recess 5. The trough depth t of the trough-like recess 5, measured along a vertical direction V (which runs orthogonally to the longitudinal direction L) of the battery housing 1, is between 10 mm and 40 mm.

The inductive charging device 26 of the battery system 25, which is arranged entirely in recess 5, serves to electrically charge the traction battery 20. For this purpose, the inductive charging device 26 is electrically connected to the traction battery 20. The inductive charging device 26 comprises at least one coil 27, shown only schematically in FIG. 2b, for receiving an alternating electromagnetic field. In an interior region 4a of the housing interior 4, which is located between the recess 5 and the upper housing part 2, there can be an electrically connected performance/control electronics 26 connected to the charging device 26 for controlling the inductive charging device 26 and an electrical connection unit 24 for the traction battery 20 may be arranged.

In the region of the recess 5, two electrical feed-throughs 15a, 15b may be provided on the lower part of the housing 3. The electrical feed-throughs allow the power and/or control electronics 22 located in the interior region 4a between the upper housing part 2 and the recess 5 to be electrically routed out of the housing interior 4 to the outside. The electrical feed-throughs 15a, 15b can each comprise an electrical plug contact 16a, 16b into which the power/control electronics 22 can be mechanically plugged.

Furthermore, in the longitudinal section shown, a mechanical reinforcement element 18a, 18b made of plastic is arranged on the outer side 9 of the lower housing part 3 facing away from the housing interior 4 in the region of the two pot collars 8a, 8b. The respective reinforcement element 18a, 18b may comprise or delimit a screw receptacle 19a, 19b for accommodating a plastic screw. This allows the inductive charging device 26 to be detachably fastened to the lower housing part 3 by means of a respective screw connection (not shown).

The mobile charging device 26 interacts with a stationary charging device 35 arranged on the roadway (not shown) that can be driven on by the motor vehicle 30 for wireless inductive energy transfer (roughly schematically indicated in FIG. 2a) from the stationary charging device 35 to the mobile charging device 26.

The recess 5 tapers conically toward the upper part of the housing 2 in the longitudinal section shown. For this purpose, the trough-like recess 5 may have a pot-like geometry with a pot base 6, as shown in FIGS. 2a and 2b, at two opposite ends 7a, 7b of which are each connected to a pot collar 8a, 8b projecting from the pot base 6. In the longitudinal section shown, the two pot collars 8a, 8b are each arranged at an acute angle a to the horizontally extending pot base 6. In the example scenario, the angle a is between 15° and 75°. The two angles a can be identical or different from each other (not shown), as shown in FIGS. 2a and 2b.

The course of the magnetic field lines FL in the region of the pot collar 8a is shown in detail in FIG. 2c. By means of the two pot collars 8a, which are inclined relative to the horizontal H-defined by the direction of extension of the pot base 6—and 8b, the course of the magnetic field lines FL in the region of the two rim regions 10a, 10b is changed in such a way that improved inductive coupling between the stationary charging device 35 and the mobile charging device 26 is achieved.

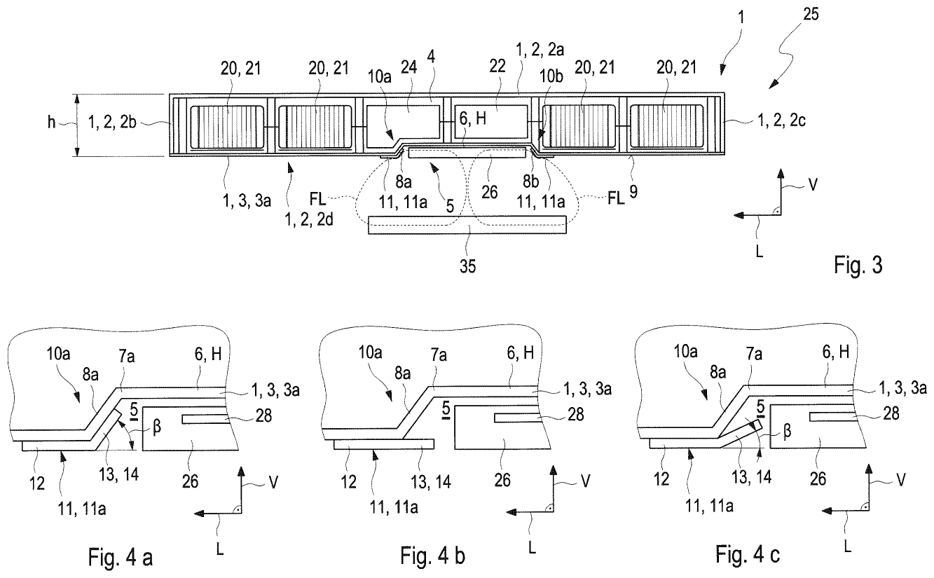

FIG. 3 shows a further development of the example in FIGS. 1 and 2. In the longitudinal section shown in FIG. 3, a magnetic conductor 11 is additionally arranged on an outer side 9 of the lower housing part 3 facing away from the housing interior 4, on two rim regions 10a, 10b of the lower housing part 3 delimiting the recess 5. The magnetic conductor 11 can be formed by a film 11a made of a magnetically conductive material, such as ferrite.

For clarification, FIG. 4a shows a detailed view of the example in FIG. 3, which shows the rim region 10a in greater detail. In the longitudinal section shown in FIGS. 3 and 4a, the film 11a has a main portion 12 arranged on the respective rim region 10a and an extension portion 13 arranged in the trough-like recess. In the longitudinal section shown, the extension portion 13 is formed as a protrusion 14 extending into the recess 5. The extension portion 13 or the protrusion 14 extends the main portion 12 and extends from the main portion 12 at an acute angle B into the recess 5. The angle β has the same value as the angle α of the respective pot collar 8a, 8b to the pot base 6 (see explanations above), so that the protrusion 14 can rest on the pot collar 8a. The magnetic conductor 11 or the film 11a can be fastened to the lower housing part 3 by means of an adhesive bond.

The mobile inductive charging device 26 may comprise a ferrite transformer core 28 as indicated in FIG. 4a. The magnetic conductor 11 or the ferrite film 1la extends towards the upper housing part 2, i.e., along the vertical direction V, at most as far as the transformer core 28.

The detailed view in FIG. 4b shows a variation of FIGS. 3 and 4a. In this variant, the extension portion 13 or the protrusion 14 extends the main portion 12 in a straight line so that the recess 5 is partially covered or closed by the extension portion 13 or by the protrusion 14.

According to a further alternative-shown in the detailed illustration in FIG. 4c—the protrusion 14 or the extension portion 13 can, in a similar manner to FIG. 4a, for example, extend at an acute angle β from the main portion 12. In contrast to FIG. 4a, however, the protrusion 14 or the extension portion 13 is arranged at a distance from the respective pot collar 8a, 8b. Therefore, the value of angle β is smaller than the value of angle α (see FIG. 2b).

The above explanations regarding rim region 10a (shown in FIGS. 4a through 4c) apply mutatis mutandis in the example scenario to rim region 10b, which is not shown in FIGS. 4a to 4c.

1. A battery housing for accommodating a traction battery of an electric or hybrid vehicle, the traction battery comprising a plurality of battery cell modules, the battery housing comprising:
an upper housing part;
a lower housing part opposite the upper housing part, the upper and lower housing parts together at least partially defining a housing interior; and
wherein, in a longitudinal section, the lower housing part defines a trough-like recess configured to accommodate an induction charging device, the recess tapering toward the upper housing part.

2. The battery housing according to claim 1, wherein
the lower housing part comprises a pot-like geometry defining the trough-like recess, the pot-like geometry including:
a pot base; and
a pot collar including a first pot collar and a second collar projecting from the pot base at opposite ends thereof;
wherein, in the longitudinal section, each pot collars is arranged at an acute angle relative to the pot base.

3. The battery housing according to claim 2, wherein acute angle is between 15° and 75°.

4. The battery housing according to claim 1, wherein the lower housing part is made of an electrically conductive material or comprises an electrically conductive material at least in a region of the recess.

5. The battery housing according to claim 2, wherein, in the longitudinal section, a magnetic conductor is arranged on an outer side of the lower housing part facing away from the housing interior, at least on a rim region of the lower housing part defining the recess.

6. The battery housing according to claim 5, wherein the magnetic conductor is a film made of a magnetically conductive material or comprises a film made of a magnetically conductive material.

7. The battery housing according to claim 6, wherein, in the longitudinal section, the film comprises a main portion arranged on the rim region and an extension portion arranged in the trough-like recess.

8. The battery housing according to claim 7, wherein
in the longitudinal section, the extension portion is a protrusion extending into the recess; and
in the longitudinal section, the protrusion extends the main portion in a straight line or extends from the main portion at an acute angle into the recess.

9. The battery housing according to claim 8, wherein
the protrusion rests on the pot collar; or
the protrusion extends at an angle into the recess and is arranged at a distance from the pot collar.

10. The battery housing according to claim 6,
wherein the magnetic conductor is made of ferrite or has a ferrite content exceeding 50% by volume.

11. The battery housing according to claim 1, wherein a trough depth of the trough-like recess measured along a vertical direction of the battery housing is between 10 mm and 40 mm.

12. The battery housing according to claim 1, wherein in the lower housing part, in a region of the recess, includes at least one electrical feed-through configured to electrically connect power and/or control electronics arranged in an interior region of the housing interior between the upper housing part and the recess to an exterior of the battery housing.

13. The battery housing according to claim 12, wherein the at least one electrical feed-through is an electrical plug contact or comprises an electrical plug contact configured for mechanical plugging of power/control electronics.

14. The battery housing according to claim 1, wherein in the longitudinal section, a mechanical reinforcement element made of plastic is arranged on outer side of the lower housing part facing away from the housing interior, in a region of the recess.

15. The battery housing according to claim 14, wherein the mechanical reinforcement element comprises a screw receptacle for a plastic screw.

16. A battery system for an electric motor vehicle, comprising:
with a battery housing according to claim 1;
with a rechargeable electric traction battery arranged in the housing interior and comprising several battery cell modules; and
with an inductive charging device arranged in the recess for electrically charging the traction battery,
the inductive charging device comprising at least one inductive coil for receiving an alternating electromagnetic field.

17. The battery system according to claim 16, wherein the inductive charging device is arranged completely within the recess.

18. The battery system according to claim 16, wherein power/control electronics electrically connected to the inductive charging device are arranged in an interior region of the housing interior between the recess and the upper housing part.

19. The battery system according to claim 16, wherein a magnetic conductor extends laterally at most to the inductive charging device.

20. The battery system according to claim 19, wherein:
the inductive charging device comprises a transformer core made of ferrite; and
the magnetic conductor extends toward the upper housing part at most up to the transformer core.

21. A motor vehicle, comprising:
a vehicle interior;
an electric drive system for powering the motor vehicle; and
a battery system according to claim 16 for supplying the electric drive system with electrical energy.

22. The motor vehicle according to claim 21, wherein:
the battery system is arranged in a lower region of the motor vehicle between the vehicle interior and an underbody of the motor vehicle; and
the upper housing part faces the vehicle interior and the lower housing part with the inductive charging device faces the underbody.
